(19) United States
(12) Patent Application Publication
(10) Pub. No.: US 2011/0240049 A1
(43) Pub. Date: Oct. 6, 2011

(54) SCISSORS WITH BENT DISTAL PORTIONS

(75) Inventors: Seung Jin Kim, Tustin, CA (US); Mincheol Kim, Tustin, CA (US)

(73) Assignee: CREVENT, INC., Tustin, CA (US)

(21) Appl. No.: 12/753,503

(22) Filed: Apr. 2, 2010

(51) Int. Cl. A45D 26/00; B26B 13/00

(52) U.S. Cl. 132/200; 30/254

(57) ABSTRACT

A pair of scissors is disclosed. The scissors includes two members that are pivotally connected. Each member includes a blade and a shank. Each blade includes a proximal portion and a distal portion that is substantially bent from the proximal portion. The distal portion is sized so as to enter a human nostril in its entirety.

### BACKGROUND

1. Field

The present disclosure relates to scissors and more particularly to scissors having bent distal portions.

2. Discussion of Related Technology

Scissors have a pair of blades pivotally rotatable relative to each other. Typically, broad surfaces of two blades are flat throughout. Some scissors have broad surfaces of two blades slightly curved. Some other scissors have blades that are bent from their shank on their narrow surfaces while flat on their broad surfaces.

### SUMMARY

One aspect of the invention provides a pair of scissors comprising: a first member comprising a first proximal portion and a first distal portion; and a second member pivotally movable relative to the first member, the second member comprising a second proximal portion and a second distal portion. The first proximal portion comprises a first proximal portion surface, and the second proximal portion comprises a second proximal portion surface configured to face and contact the first proximal portion surface. The first distal portion comprises a first distal portion surface, and the second distal portion comprises a second distal portion surface configured to face and contact the first distal portion surface. The first distal portion surface may be substantially bent from the first portion surface by a first angle, and the second distal portion surface may be substantially bent from the second proximal portion surface by a second angle.

In the foregoing scissors, the first and second angles may be substantially the same. The first and second angles may be within a range from about 35° to about 65°. The first proximal portion surface may be substantially flat, and the first distal portion surface may be substantially flat. A first intervening surface interconnects between the first proximal portion surface and the first distal portion surface, and the first intervening surface may be substantially curved. The first distal portion may be sized such that the first distal portion in its entirety enters a human nostril. The first distal portion may have a length between about 2.5 mm and about 6.5 mm. The first distal portion may be movable relative to the second distal portion between an overlapping position and a non-overlapping position as the first member pivotally moves relative to the second member. The first and second distal portion in combination may provide a substantially round tip in the overlapping configuration.

Another aspect of the invention provides a method of cutting nostril hair. The method comprises: providing the foregoing scissors; placing both the first and second distal portions into a human nostril; and pivotally moving the first member relative to the second blade while maintaining the first and second distal portions within the nostril. The method may further comprise: holding the scissors in an orientation in which at least one of the first and second distal portions is aligned, within the nostril, substantially vertically. The method may further comprise: holding the scissors in an orientation in which at least one of the first and second distal portions is aligned, within the nostril, substantially parallel to an interior surface of a partitioning wall that partitions between two nostril cavities of the human nose.

A still other aspect of the invention provides a pair of scissors, which comprises: a first member comprising a first shank and a first blade integral with the first shank, the first blade comprising a first proximal portion and a first distal portion that is substantially bent relative to the first proximal portion, the first distal portion being sized so as to enter a human nostril in its entirety; and a second member pivotally movable relative to the first member, the second member comprising a second shank and a second blade integral with the second shank, the second blade comprising a second proximal portion and a second distal portion that is substantially bent relative to the second proximal portion, the second distal portion being sized so as to enter the human nostril in its entirety.

In the foregoing scissors, the first proximal portion may comprise a first proximal portion surface configured to face and contact the second proximal portion, and the first distal portion may comprise a first distal portion surface configured to face and contact the second distal portion. The first distal portion surface may be bent relative to the first proximal portion surface at an acute angle from about 25° to about 75°. The first proximal portion surface may be substantially flat, and the first distal portion surface may be substantially flat. A first intervening surface interconnects between the first proximal portion surface and the first distal portion surface, and the first intervening surface may be substantially curved.

The first proximal portion may comprise a first proximal portion surface, and the first distal portion may comprise a first distal portion surface. The first proximal portion may be configured to move in an imaginary plane as the first member pivotally moves relative to the second member, and the first distal portion surface may be bent from the imaginary plane at an acute angle from about 20° to about 70°. The first proximal portion surface may be slightly curved, and the first distal portion surface may be substantially flat or slightly curved. A first intervening surface interconnects between the first proximal portion surface and the first distal portion surface, and the first intervening surface may be substantially curved. The first blade further may comprise a first curved portion interposed between the first proximal portion and the first distal portion, and second blade further may comprise a second curved portion interposed between the second proximal portion and the second distal portion. The first distal portion may have a length from about 3 mm to about 6 mm.

A further aspect of the invention provides a method of cutting nostril hair. The method comprises: providing the foregoing scissors; placing the first and second distal portions into a nostril of a human nose; and pivotally moving the first blade relative to the second blade while maintaining the first and second distal portions within the nostril, thereby trimming nostril hair with sliding actions of the first distal portion with respect to the second distal portion as the first member pivotally moves relative to the second blade. The method may further comprise: holding the scissors in an orientation in which at least one of the first and second distal portions is aligned, within the nostril, substantially parallel to an interior surface of the nostril, wherein pivotally moving the first blade relative to the second blade cuts hair extending from the interior surface. The method may further comprise: holding the scissors in an orientation in which at least one of the first and second distal portions is aligned substantially perpendicular to an interior surface of a partitioning wall that partitions between two nostril cavities of the human nose.

A further aspect of the invention provides a pair of scissors. The scissors comprise: a first blade comprising a first proximal portion and a first distal portion integrally extending from the first proximal portion; a second blade pivotally rotatable relative to the first blade between an overlapping position and a non-overlapping position, the second blade comprising a second proximal portion and a second distal portion integrally extending from the second proximal portion; the first proximal portion comprising a first proximal portion surface; the first distal portion comprising a first distal portion surface, which extends from the first proximal portion surface while substantially bent from the first proximal portion surface, wherein the first distal portion is sized such that the entire portion of the first distal portion enters a human nostril; the second proximal portion comprising a second proximal portion surface, wherein at the overlapping position the second proximal portion surface substantially overlaps with the first proximal portion surface when viewed in a direction perpendicular to the first proximal portion surface; and the second distal portion comprising a second distal portion surface extending from the second proximal portion surface while substantially bent from the second proximal portion surface, wherein the second distal portion is sized such that the entire portion of the second distal portion enters a human nostril.

In the foregoing scissors, the first distal portion may have a length from the proximal portion between about 2.5 mm and about 6.5 mm. The first distal portion may be bent from the first proximal portion at an acute angle from about 35° to about 65°. The first blade may comprise a curved portion between the first proximal portion and the first distal portion. The first distal portion may comprise a substantially rounded end.

A further aspect of the invention provides a method of cutting nostril hair. The method comprises: providing the foregoing scissors; placing both the first and second distal portions into a nostril cavity of a human nose; and pivotally moving the first blade relative to the second blade while maintaining the first and second distal portions within the nostril. The method may further comprise: holding the scissors in an orientation in which at least one of the first and second distal portions is aligned, within the nostril, substantially vertically. The method may further comprise: holding the scissors in an orientation in which at least one of the first and second distal portions is aligned, within the nostril, substantially parallel to an interior surface of a partitioning wall that partitions between two nostril cavities of the human nose.

A still further aspect of the invention provides a pair of nostril hair scissors. The scissors comprise: a first member comprising a first shank and a first blade integral with the first shank, the first blade comprising a first proximal portion and a first distal portion that is bent relative to the first proximal portion, the first distal portion being sized so as to enter a human nostril in its entirety; and a second member coupled with the first member and pivotally movable relative to the first member about a pivotal axis, the second member comprising a second shank and a second blade integral with the first shank, the second blade comprising a second proximal portion and a second distal portion that is bent relative to the second proximal portion, the second distal portion being sized so as to enter the human nostril in its entirety.

In the foregoing scissors, the first proximal portion may comprise a first proximal portion surface, the first distal portion may comprise a first distal portion surface continuous from the first proximal portion surface, the first distal portion surface may be bent at an acute angle from an imaginary plane that extends from the first proximal portion surface and overlaps with the first distal portion surface when viewed in a direction parallel to the pivot axis. The acute angle may be from about 20° to about 70°. The first blade may further comprise a first curved portion interposed between the first proximal portion and the first distal portion, and the second blade may further comprise a second curved portion interposed between the second proximal portion and the second distal portion. The first proximal portion may comprise a first proximal portion surface, the first distal portion may comprise a first distal portion surface, and the first curved portion may comprise a first curved surface smoothly connecting the first proximal portion surface and the first distal portion surface therebetween. The first distal portion may have a length from about 3 mm to about 6 mm from the first proximal portion. The first distal portion may comprise a distal end portion that is substantially rounded.

A still further aspect of the invention provides a method of cutting nostril hair. The method comprises: providing the foregoing scissors; placing both the first and second distal portions into a nostril of a human nose; and pivotally moving the first blade relative to the second blade while maintaining the first and second distal portions within the nostril, thereby cutting nostril hair with sliding actions of the first distal portion with respect to the second distal portion as the first blade pivotally moves relative to the second blade.

The foregoing method may further comprise: holding the scissors in an orientation in which at least one of the first and second distal portions may be aligned, within the nostril, substantially parallel to an interior surface of the nostril, wherein pivotally moving the first blade relative to the second blade cuts hair extending from the interior surface. The method may further comprise: holding the scissors in an orientation in which at least one of the first and second distal portion surfaces is aligned substantially horizontally within the nostril. The method may further comprise: holding the scissors in an orientation in which at least one of the first and second distal portions is aligned substantially perpendicular to an interior surface of a partitioning wall that partitions between two nostril cavities of the human nose.

### BRIEF DESCRIPTION OF DRAWINGS

FIG. 1 is a perspective view of scissors according to one embodiment of the present invention.

FIG. 2 is another perspective view of the scissors of FIG. 1 in the most overlapping configuration

FIG. 3 is an enlarged view of a circled portion of the scissors of FIG. 1.

FIG. 4 illustrates a cross-section of a human nose showing nostril cavities and nostril hair strands within the human nostril cavities.

FIGS. 5A and 5B illustrate various orientations of the scissors of FIG. 1 for trimming human nostril hair according to embodiments of the present invention.

FIG. 6A illustrates a pair of nostril hair scissors with two straight blades.

FIG. 6B illustrates the nostril hair scissors of FIG. 6A in two trimming orientations.

FIG. 7A illustrates a pair of nostril hair scissors with two slightly curved blades.

FIG. 7B illustrates the nostril hair scissors of FIG. 6A in two trimming orientations.

### DETAILED DESCRIPTION OF EMBODIMENTS

Various embodiments of the invention will be discussed in more detail below, with reference to the drawings, wherein like elements are generally referred to with like numerals throughout. The sizes and shapes of elements shown in the drawings do not represent actual sizes or shapes, nor represent relative sizes of the elements shown in a single drawing.

### Scissors

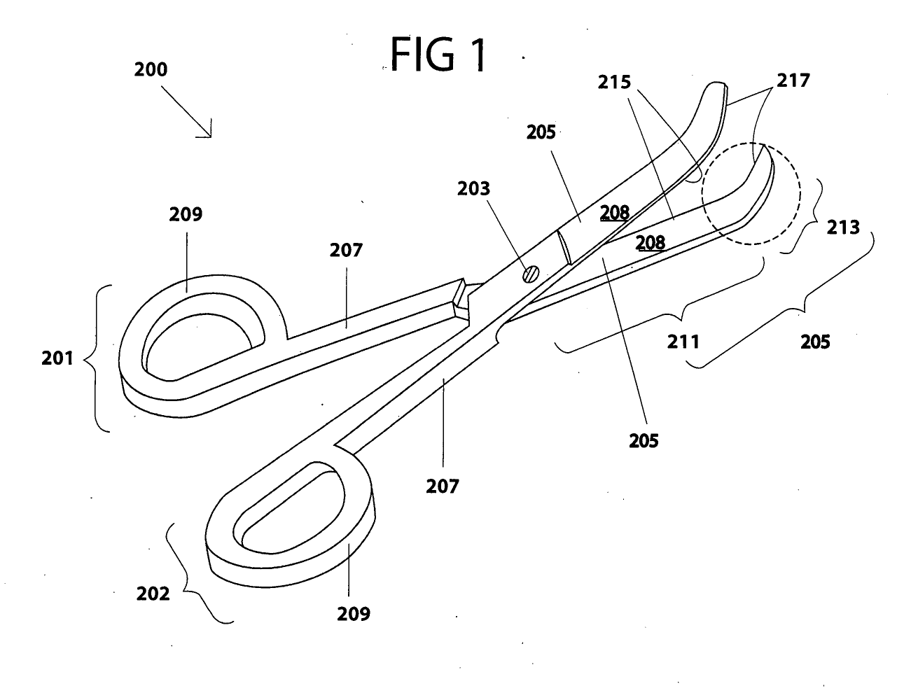

FIGS. 1-3 illustrate a pair of scissors in accordance with one embodiment of the invention. The illustrated scissors 200 includes a first member 201 and a second member 202, which are connected to each other via a pivot 203. The first and second members 201 and 202 are pivotally movable or rotatable relative with each other about the pivot 203. The first and second members 201 and 202 respectively include a blade 205 and a shank 207. As illustrated, each blade 205 includes a proximal portion 211, a distal portion 213, which is bent from the proximal portion 211. Each shank 207 includes a finger gripping portion 209 with a finger hole.

In the illustrated embodiment, each proximal portion 211 has a cutting edge 215, and each distal portion 213 has a cutting edge 217. The cutting edge 215 of each proximal portion 211 is substantially straight, bent or curved. Likewise, the cutting edge 217 of each distal portion 213 is substantially straight, bent or curved. The cutting edge 217 of the distal portion 213 bent from the cutting edge 215 of the proximal portion 211 with a curved portion therebetween. In operation, as the two shanks 207 pivotally get closer to each other, the two blades 205 get closer to each other and slide relative to each other. Then, two opposing cutting edges of the first and second members 201 and 202 slide relative to each other and thereby cut things placed between them.

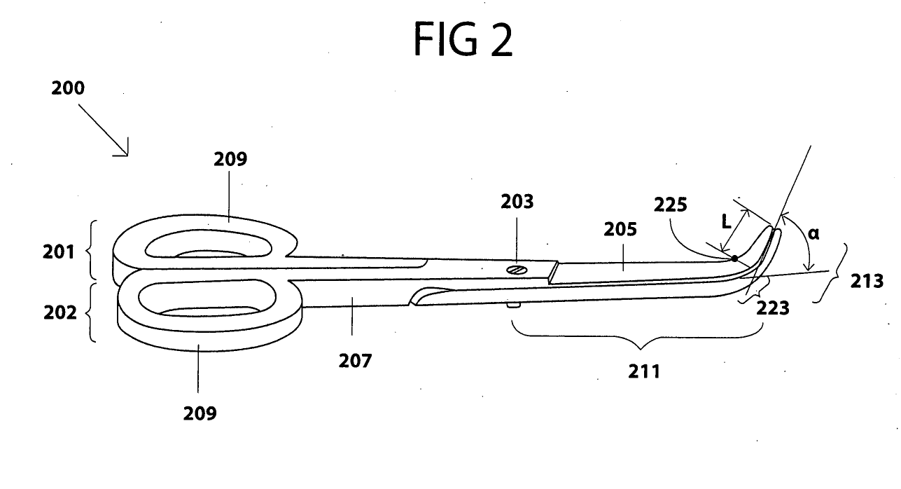

On the other side of the cutting edge 217, the distal portion 213 includes a rounded or curved edge near its end 227. When the blades 205 are at its most overlapping configuration (FIG. 2), the rounded edges of the two distal portions 213 in combination form a rounded end such that the end of the scissors 200 in that configuration is not sharp.

Each blade 205 has two broad surfaces 208 and two narrow surfaces interconnecting the two broad surfaces 208 thereof. In the illustrated embodiment, the two broad surfaces 208 of each blade 205 are substantially parallel with each other, although not limited thereto. One broad surface 208 of the first member 201 faces one broad surface 208 of the second member 202. These facing surfaces 208 of the first and second members 201 and 202 slide and at least partly contact with each other as the first and second members 201 and 202 pivotally moves. In the embodiment, the two facing surfaces 208 of the first and second members 201 and 202 are generally parallel with each other throughout the blades 205. As the first member 201 pivotally moves relative to the second member 202, the blade of the first member 202 slides in an imaginary plane, provided that the second member stays still.

### Bending of the Blade

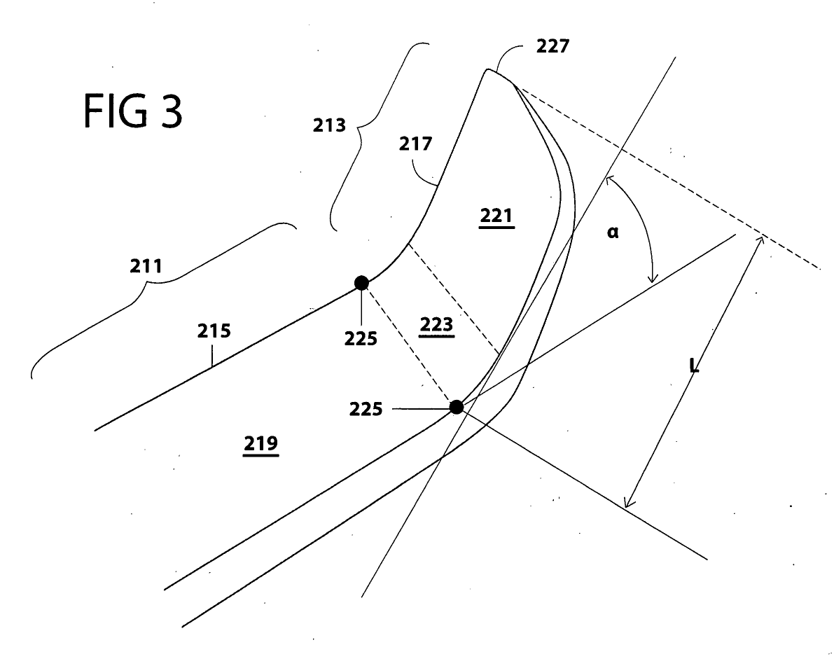

Referring to FIGS. 1-3, each blade 205 has its distal portion 213 significantly bent from its proximal portion 211. Referring to FIG. 3, the facing surface 208 of the blade 205 of the first member 201 includes a proximal portion surface 219, a distal portion surface 221 and an intervening portion surface 223. In the illustrated embodiment, the proximal portion surface 219 is substantially flat, and the distal portion surface 221 is also substantially flat. In other embodiments, either or both of the surfaces 219 and 221 are slightly curved, in which either of the surfaces 219 and 221 is substantially bent.

In the illustrated embodiment, the distal portion surface 221 is substantially bent from the proximal portion surface 219. The intervening portion surface 223 is curved and smoothly interconnects between the proximal portion surface 219 and the distal portion surface 221. As illustrated, the distal portion surface 221 (and the distal portion 213) is bent from the proximal portion surface 219 (and the proximal portion 211) by an angle (α). As the first member 201 pivotally moves relative to the second member 202, the proximal portion 211 of the blade 205 moves in an imaginary plane parallel to the proximal portion surface 219. Thus, the distal portion surface 221 (and the distal portion 213) is bent by the angle (α) from the imaginary plane in which the proximal portion surface 219 (and the proximal portion 211) slides.

Although not illustrated, the facing surface of the blade 205 of the second member 202 has surfaces that correspond to the proximal portion surface 219, the distal portion surface 221 and the intervening portion surface 223. Therefore, the distal portion surface of the second member 202 is substantially bent from the proximal portion surface thereof, e.g., by the angle (α). Also, the distal portion surface of the second member 202 is substantially bent from the imaginary plane in which the proximal portion 211 (and the proximal portion surface 219) slides.

### Degree of Bending

In the illustrated embodiments, bending of the distal portion 213 from the proximal portion 211 is measured by the angle (α). between the proximal portion surface 219 and the distal portion surface 221. In some embodiments where either or both of the proximal and distal portion surfaces 219 and 221 are curved, the angle (α) of bending between the distal portion 213 from the proximal portion 211 is defined to be the maximum angle that the proximal and distal portion surfaces 219 and 221 can make therebetween. In various embodiments, the angle (α) is about 10°, about 12°, about 14°, about 16°, about 18°, about 20°, about 22°, about 24°, about 26°, about 28°, about 30°, about 32°, about 34°, about 36°, about 38°, about 40°, about 42°, about 44°, about 46°, about 48°, about 50°, about 52°, about 54°, about 56°, about 58°, about 60°, about 62°, about 64°, about 66°, about 68°, about 70°, about 72°, about 74°, about 76°, about 78°, and about 80°. Further, the angle (α) is in a range between about any two of the angles listed in the foregoing sentence.

### Relative Length of Bent Portion

In embodiments, the ends 227 of both the distal portions 213 overlap and/or contact each other when the blades 205 of the first and second members 201, 202 are in their most overlapping configuration. Referring to FIG. 2, the blades 205 of the first and second members 201, 202 are in their most overlapping configuration, and the blade 205 of the first member 201 is positioned behind the blade 205 of the second member 202. To make the ends 227 of both the distal portions 213 contact and/or overlap each other, in embodiments, the distal portion 213 of the first member 201 is slightly longer than the distal portion 213 of the second member 202. In other words, when viewing the scissors 200 in a direction perpendicular to the distal portion surface 221, the distal portion 213 of the first member 201 is slightly longer than the distal portion 213 of the second member 202, thereby the ends 227 of the two distal portions 213 generally meet each other.

In embodiments, the distal portion 213 of the first member 201 is longer than the distal portion 213 of the second member 202 by about the thickness of the second member 202 in its bent portion between the distal portion 213 and the proximal portion 211. In embodiments, the distal portion 213 of the first member 201 is longer than the distal portion 213 of the second member 202 by about the thickness of the first member 201 in its bent portion between the distal portion 213 and the proximal portion 211. In embodiments, the length (L) of the front distal portion is shorter than that of the back distal portion by about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, and about 3 mm. Further, the difference between the lengths (L) of the distal portions 213 is in a range between about any two of the length listed in the foregoing sentence.

### Use as Nostril Hair Trimming

The scissors 200 according to embodiments of the invention can be used in various situations for cutting or trimming certain objects. According to one embodiment, the scissors 200 can be used in trimming nostril hair. The distal portion 213 bent from the proximal portion 211 of the blade 205 is adapted to trim nostril hair within a human nostril cavity 107. Because human nostril cavities are shaped like shallow channels, orientations nostril hair scissors are generally limited when trimming nostril hair. According to embodiments, however, the illustrated scissors 200 are advantageously designed for trimming nostril hair.

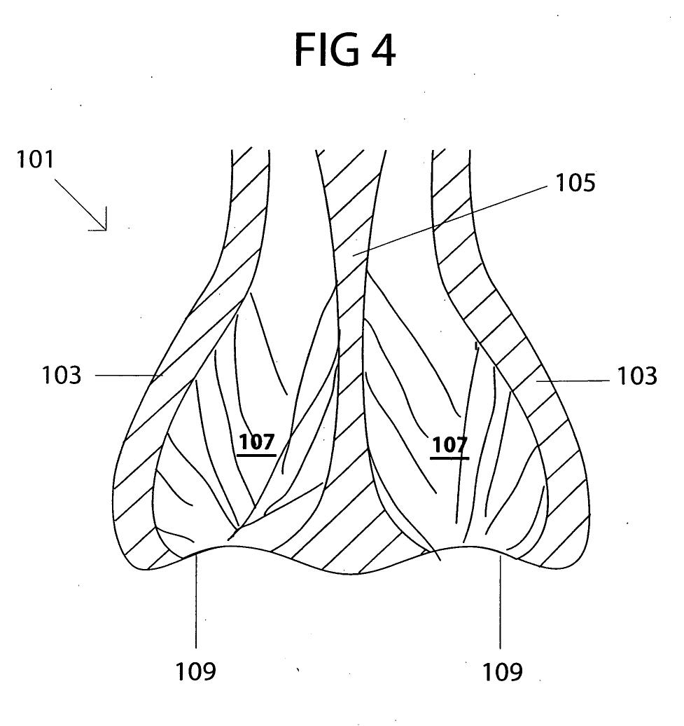

Referring to FIG. 4, a human nose 101 includes two side walls 103 and a partitioning wall 105. As illustrated, the side walls 103 and the partitioning wall 105 define two nostril cavities or simply nostrils 107. Nostril hair strands are rooted in the interior surfaces of the side walls 103 and the partitioning wall 105. The nostril hair strands grow naturally and need trimming from time to time to prevent them from sticking out of the nostril openings 109. As will be discussed further, the distal portions 213 of the scissors 200 enter the nostril openings 109 and are configured to cut hair strands within the nostril cavities.

Length of Bent Distal portion

In embodiments, the distal portions 213 are sized such that the whole distal portions 213 can enter into a human nostril. The length (L) of the distal portion 213 is from a bending point 225 of the distal portion 213 to the end 227 of the distal portions 213. In some embodiments, although not illustrated, bending between the proximal portion 211 and the distal portion 213 is rather abrupt, and a bending point 225 for the purpose of measuring the length (L) can be relatively distinct. In the embodiment of FIGS. 2, 3 and 4, however, the distal portion 213 and the proximal portion 211 are connected via a smooth curvature in the intervening portion surface 223, and the bending point 225 may not difficult to locate. When the bending point is not distinct, the end of the curvature in the intervening portion surface 223 toward the proximal portion 211 is considered the bending point 225 for the purpose of measuring the length (L).

In various embodiments, the length (L) of the distal portion 213 is about 3 mm, about 3.25 mm, about 3.5 mm, about 3.75 mm, about 4 mm, about 4.25 mm, about 4.5 mm, about 4.75 mm, about 5 mm, about 5.25 mm, about 5.5 mm, about 5.75 mm, about 6 mm, about 6.25 mm, about 6.5 mm, about 6.75 mm, about 7 mm, about 7.25 mm, about 7.5 mm, about 7.75 mm, about 8 mm, about 8.25 mm, about 8.5 mm, about 8.75 mm, about 9 mm, about 9.25 mm, about 9.5 mm, about 9.75 mm, about 10 mm, about 10.25 mm, about 10.5 mm, about 10.75 mm, about 11 mm, about 11.25 mm, about 11.5 mm, about 11.75 mm, about 12 mm, about 12.25 mm, about 12.5 mm, about 12.75 mm, about 13 mm, about 13.25 mm, about 13.5 mm, about 13.75 mm, about 14 mm, about 14.25 mm, about 14.5 mm, about 14.75 mm, about 15 mm, about 15.25 mm, about 15.5 mm, about 15.75 mm, about 16 mm, about 16.25 mm, about 16.5 mm, about 16.75 mm, about 17 mm, about 17.25 mm, about 17.5 mm, about 17.75 mm, about 18 mm, about 18.25 mm, about 18.5 mm, about 18.75 mm, about 19 mm, about 19.25 mm, about 19.5 mm, about 19.75 mm, about 20 mm. Further, the length (L) of the distal portion 213 is in a range between about any two of the length listed in the immediately previous sentence.

### Manufacturing of Nostril Hair Scissors

In embodiments, the first and second members 201, 201 are individually manufactured using processes and techniques that are available at the time of manufacturing. For example, the first and second members 201, 202 are made by forging and/or pressing processes, although not limited thereto. Then, the scissors 200 is assembled by pivotally connecting the first member 201 and the second member 202 with the pivot 203. Skilled artisans in the relevant technology will be able to incorporate various features disclosed herein into manufacturing of the first and second members 201, 202 and the nostril hair scissors 200, using various available technologies.

### Trimming Nostril Hair

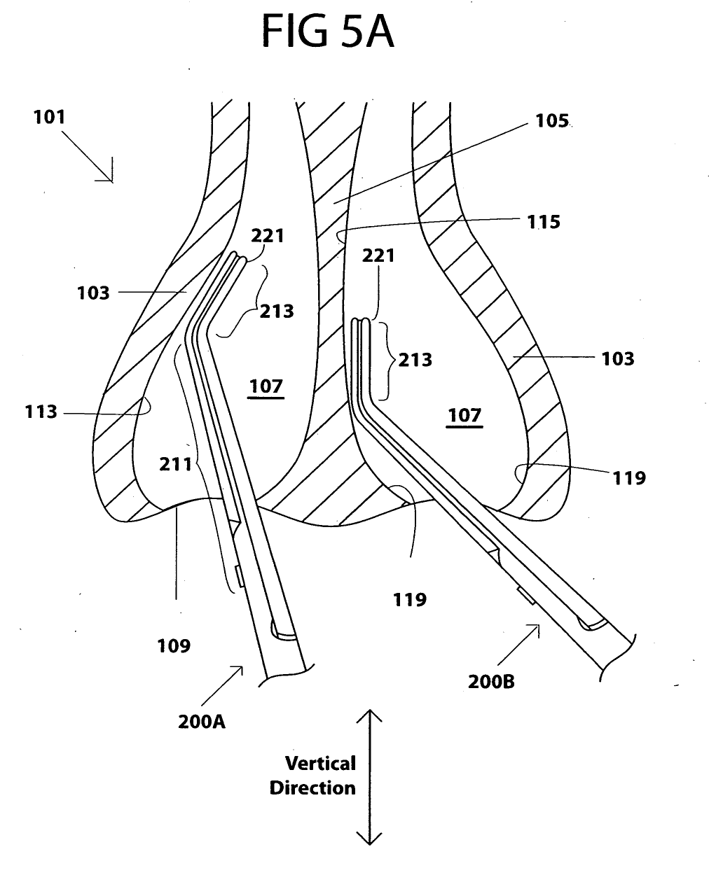

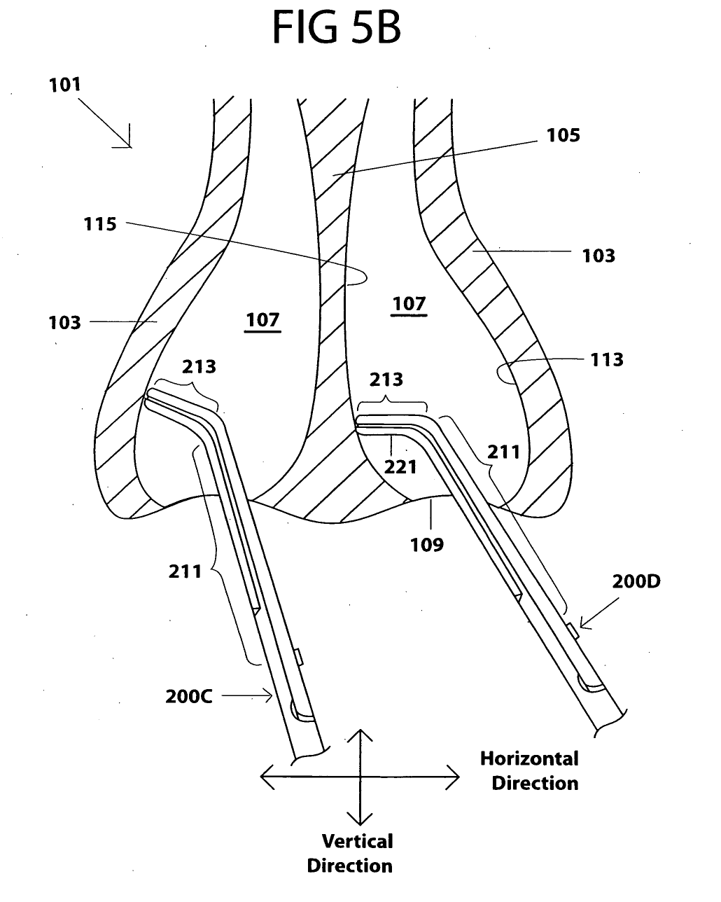

Now discussed is trimming of nostril hair strands using the scissors 200. In the illustrated embodiments of FIGS. 5A and 5B, the entire distal portions 213 of the scissors 200 enter into a nostril cavity 107. Also, the distal portions 213 can pivotally slide with each other within one of the nostril cavities 107. In other embodiments, however, the entire distal portions 213 do not need to enter the nostril cavities 107, and only a portion of each distal portion 213 may enter the nostril cavity 107 for cutting nostril hair strands.

### Freedom of Orientation and Alignment

In the embodiments where the distal portions 213 are sized to enter a human nostril, the nostril hair scissors 200 will provide substantial freedom in its orientations when trimming nostril hair. In embodiments, the distal portions 213 can be aligned in almost any directions within the nostril cavity 107. The distal portions 213 can be parallel or perpendicular, within the nostril cavity 107, to interior surfaces 113, 115 and other non-illustrated surfaces. Also, the distal portions 213 can be vertically or horizontally oriented within the nostril cavity 107

### Parallel Alignment

Referring to FIG. 5A, the distal portions 213 of scissors 200A, 200B are be aligned, within the nostril cavity 107, substantially parallel to interior surfaces 113, 115. The alignments of the distal portions 213 in substantially parallel to interior surfaces are simply called herein parallel alignment. In a parallel alignment, one of the distal portions 213 can reach the interior surface 113, 115 very closely with or without contacting the surface and therefore can effectively trim nostril hair strands extending from those surfaces 113, 115. Further, in a parallel alignment, one of the distal portions 213 can contact the surface 113, 115 with which it is parallel, while the proximal portions 211 of the scissors 200A, 200B do not contact the nose wall 103 or rim portion 119.

### Vertical Alignment

Still in FIG. 5A, the distal portions 213 of the nostril hair scissors 200B are aligned generally vertically inside the nostril cavity 107, which is referred to as a vertical alignment. In vertical alignments, the distal portions 213 extend generally in a vertical direction. The vertical alignment is also a parallel alignment as the distal portions 213 are aligned generally parallel to the interior surface 115 within the nostril cavity 107. As illustrated, in parallel and vertical alignments, the proximal portions 211 are substantially bent from or off the vertical direction.

### Perpendicular Alignment

Referring to FIG. 5B, the extension of the distal portions 213 of the scissors 200C, 200D are aligned, within the nostril cavity 107, substantially perpendicular to interior surfaces 113, 115 and other interior surfaces. For the interior surface 113, which is curved, the distal portion 213 is substantially perpendicular to a tangent of the surface 113 at the point where the distal portions point. The alignments of the distal portions 213 in substantially perpendicular to interior surfaces are simply called herein perpendicular alignment.

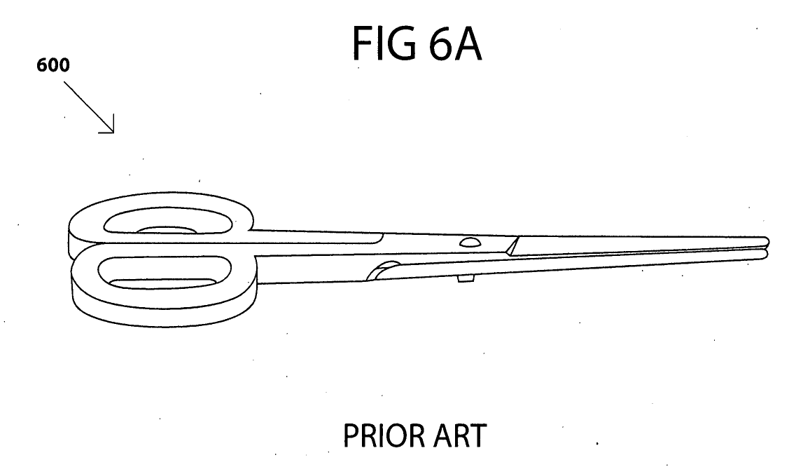

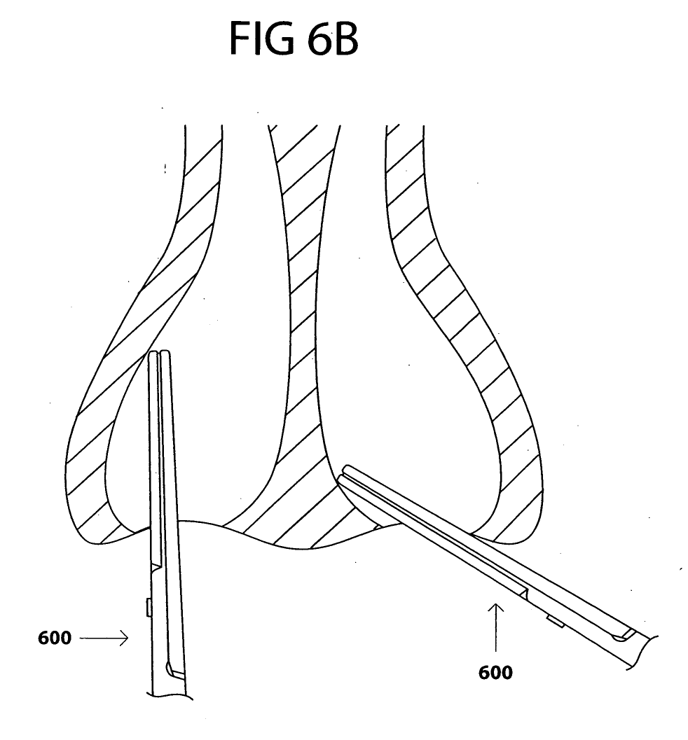

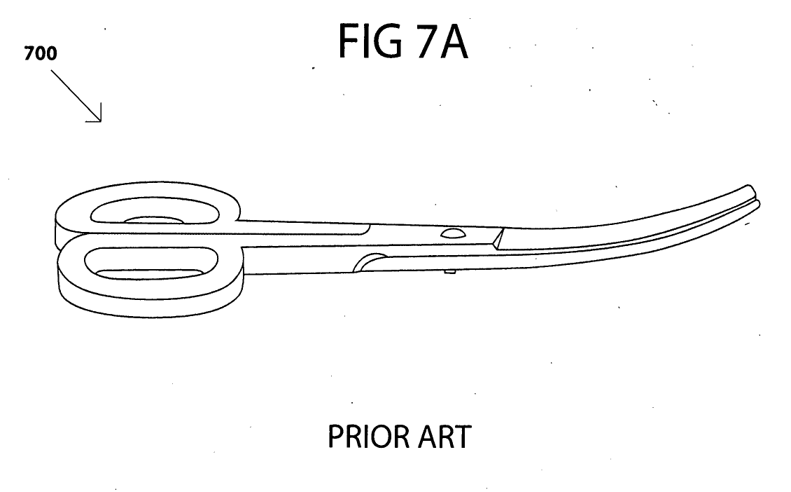

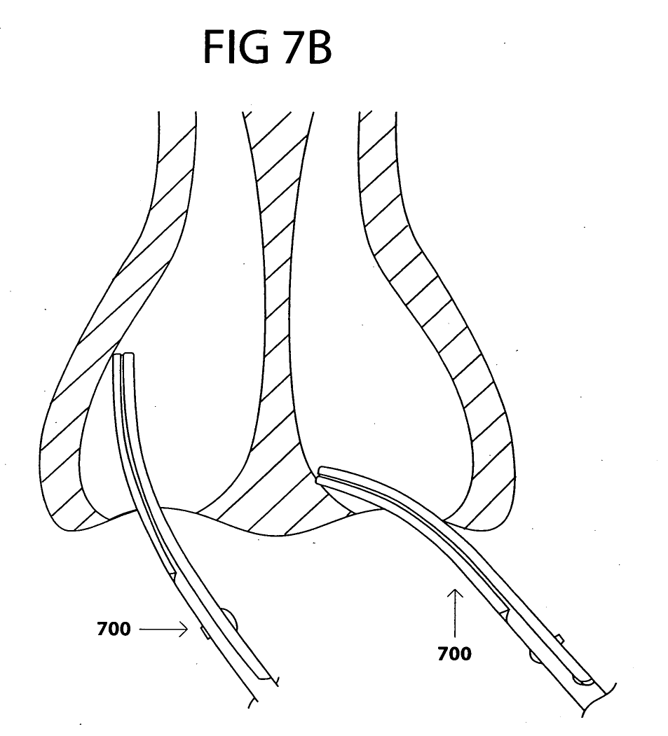

The perpendicular alignments can be possible within the nostril cavity 107 without making a contact between the distal portions 213 and the interior surfaces 113, 115. Also, in some embodiments, perpendicular alignments can be possible with no or little pushing of any part of the nose wall 103 or the rim portions 119 by a portion of the scissors 200C, 200D. Such pushing would disfigure the pushed portion of the nose, which would have be inevitable in the nostril hair scissors 600, 700 of FIGS. 6 and 7 that do not have a substantial bending of the distal portion 213 from the proximal portion 211.

### Horizontal Alignment

Still referring to FIG. 5B, the distal portions 213 of the right scissors 200D are aligned generally horizontally within the nostril cavity 107, which is referred to as a horizontal alignment. In horizontal alignments, the distal portions 213 extend generally parallel to a horizontal direction, i.e., generally perpendicular to the vertical direction. A horizontal alignment is also a perpendicular alignment as the distal portions 213 are aligned generally perpendicular to the interior surface 115 within the nostril cavity 107. As illustrated, in the horizontal alignment, the proximal portions 211 are substantially bent from or off the vertical direction. The horizontal alignments make trimming nostril hair very effective as the surface 221 of the distal portion 213 can be as much perpendicular as possible to those hair strands that extend generally vertically inside the cavity 107. Such horizontal alignments, within the nostril cavity 107, would not be possible in other nostril hair scissors 600, 700 of FIGS. 6 and 7, in which two blades 601, 701 are straight throughout or only slightly curved throughout without a bent portion.

In the horizontal alignments, the distal portions 213 can enter relatively deep into the nostril cavity 107. Thus, vertically extending hair strands can be cut short. In embodiments, the distal portions 213 are horizontally aligned while they are inside the nostril cavity 107 at a depth from the nostril opening 109. Here, the depth is measured by the shortest distance (D) between the bending point 225 and the nostril opening 109. In embodiments, the distance (D) is about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, about 10 mm, about 10.5 mm, about 11 mm, about 11.5 mm, about 12 mm, about 12.5 mm, about 13 mm, about 13.5 mm, about 14 mm, about 14.5 mm, and about 15 mm. In embodiments, the distance is greater than about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, about 10 mm, about 10.5 mm, about 11 mm, about 11.5 mm, about 12 mm, about 12.5 mm, about 13 mm, about 13.5 mm, about 14 mm, about 14.5 mm, and about 15 mm.

Turning/Changing Alignment within Nostril Cavity

In embodiments where the distal portions 213 are sized to enter a human nostril, the scissors 200 will provide substantial freedom in turning or changing its orientation while trimming nostril hair. In embodiments, the distal portions 23 can turn or change its orientations within the nostril cavity 107 without having to be taken to outside the nostril cavity 107. For example the distal portions 213 can change its alignment, within the nostril cavity 107, between two parallel alignments, between two perpendicular alignments, and between a parallel alignment and a perpendicular alignment. Further, for example, the distal portions 213 can change the alignment, within the nostril cavity 107, between a parallel alignment and a vertical alignment, between a vertical alignment and a horizontal alignment, between a parallel alignment and a vertical alignment, and between a perpendicular alignment and a vertical alignment.

### Possible Modifications

It is to be understood that persons of skill in the appropriate arts may modify the features and embodiments described herein while still achieving the favorable results of this invention. Accordingly, the foregoing description is to be understood as being a broad, teaching disclosure directed to persons of skill in the appropriate arts, and not as limiting upon the invention.

What is claimed is:

1. A pair of scissors comprising:
a first member comprising a first proximal portion and a first distal portion;
a second member pivotally movable relative to the first member, the second member comprising a second proximal portion and a second distal portion;
wherein the first proximal portion comprises a first proximal portion surface, and the second proximal portion comprises a second proximal portion surface configured to face and contact the first proximal portion surface;
wherein the first distal portion comprises a first distal portion surface, and the second distal portion comprises a second distal portion surface configured to face and contact the first distal portion surface; and
wherein the first distal portion surface is substantially bent from the first portion surface by a first angle, and the second distal portion surface is substantially bent from the second proximal portion surface by a second angle.

2. The scissors of claim 1, wherein the first and second angles are substantially the same.

3. The scissors of claim 1, wherein the first and second angles are within a range from about 35° to about 65°.

4. The scissors of claim 1, wherein the first proximal portion surface is substantially flat, and the first distal portion surface is substantially flat, wherein a first intervening surface interconnects between the first proximal portion surface and the first distal portion surface, wherein the first intervening surface is substantially curved.

5. The scissors of claim 1, wherein the first distal portion is sized such that the first distal portion in its entirety enters a human nostril.

6. The scissors of claim 1, wherein the first distal portion has a length between about 2.5 mm and about 6.5 mm.

7. The scissors of claim 1, wherein the first distal portion is movable relative to the second distal portion between an overlapping position and a non-overlapping position as the first member pivotally moves relative to the second member, wherein the first and second distal portion in combination provides a substantially round tip in the overlapping configuration.

8. A method of cutting nostril hair, the method comprising:
providing the scissors of claim 1;
placing both the first and second distal portions into a human nostril; and
pivotally moving the first member relative to the second blade while maintaining the first and second distal portions within the nostril.

9. The method of claim 8, further comprising:
holding the scissors in an orientation in which at least one of the first and second distal portions is aligned, within the nostril, substantially vertically.

10. The method of claim 8, further comprising:
holding the scissors in an orientation, in which at least one of the first and second distal portions is aligned, within the nostril, substantially parallel to an interior surface of a partitioning wall, which partitions between two nostril cavities of the human nose.

11. A pair of scissors comprising:
a first member comprising a first shank and a first blade integral with the first shank, the first blade comprising a first proximal portion and a first distal portion that is substantially bent relative to the first proximal portion, the first distal portion being sized so as to enter a human nostril in its entirety; and
a second member pivotally movable relative to the first member, the second member comprising a second shank and a second blade integral with the second shank, the second blade comprising a second proximal portion and a second distal portion that is substantially bent relative to the second proximal portion, the second distal portion being sized so as to enter the human nostril in its entirety.

12. The scissors of claim 11, wherein the first proximal portion comprises a first proximal portion surface configured to face and contact the second proximal portion, and the first distal portion comprises a first distal portion surface configured to face and contact the second distal portion, wherein the first distal portion surface is bent relative to the first proximal portion surface at an acute angle from about 25° to about 75°.

13. The scissors of claim 12, wherein the first proximal portion surface is substantially flat, and the first distal portion surface is substantially flat, wherein a first intervening surface interconnects between the first proximal portion surface and the first distal portion surface, wherein the first intervening surface is substantially curved.

14. The scissors of claim 11, wherein the first proximal portion comprises a first proximal portion surface, and the first distal portion comprises a first distal portion surface, wherein the first proximal portion is configured to move in an imaginary plane as the first member pivotally moves relative to the second member, wherein the first distal portion surface is bent from the imaginary plane at an acute angle from about 20° to about 70°.

15. The scissors of claim 14, wherein the first proximal portion surface is slightly curved, and the first distal portion surface is substantially flat or slightly curved, wherein a first intervening surface interconnects between the first proximal portion surface and the first distal portion surface, wherein the first intervening surface is substantially curved.

16. The scissors of claim 11, wherein the first blade further comprises a first curved portion interposed between the first proximal portion and the first distal portion, wherein the second blade further comprises a second curved portion interposed between the second proximal portion and the second distal portion.

17. The scissors of claim 11, wherein the first distal portion has a length from about 3 mm to about 6 mm.

18. A method of cutting nostril hair, the method comprising:
providing the scissors of claim 12;
placing the first and second distal portions into a nostril of a human nose; and
pivotally moving the first blade relative to the second blade while maintaining the first and second distal portions within the nostril, thereby trimming nostril hair with sliding actions of the first distal portion with respect to the second distal portion as the first member pivotally moves relative to the second blade.

19. The method of claim 18, further comprising:
holding the scissors in an orientation in which at least one of the first and second distal portions is aligned, within the nostril, substantially parallel to an interior surface of the nostril, wherein pivotally moving the first blade relative to the second blade cuts hair extending from the interior surface.

20. The method of claim 12, further comprising:
holding the scissors in an orientation in which at least one of the first and second distal portions is aligned substantially perpendicular to an interior surface of a partitioning wall that partitions between two nostril cavities of the human nose.
